(19) United States
(12) Patent Application Publication
(10) Pub. No.: US 2015/0169345 A1
(43) Pub. Date: Jun. 18, 2015

(54) SOFTWARE-DEFINED NETWORKING (SDN) FOR MANAGEMENT OF TRAFFIC BETWEEN VIRTUAL PROCESSORS

(71) Applicant: International Business Machines Corporation, Armonk, NY (US)

(72) Inventors: Casimer M. DeCusatis, Poughkeepsie, NY (US); Rajaram B. Krishnamurthy, Wappingers Falls, NY (US)

(73) Assignee: International Business Machines Corporation, Armonk, NY (US)

(21) Appl. No.: 14/132,135

(22) Filed: Dec. 18, 2013

(51) Int. Cl. G06F 9/455; G06F 9/54

(52) U.S. Cl. CPC G06F 9/45545; G06F 9/541

(57) ABSTRACT

An aspect includes receiving, at a software-defined networking (SDN) controller, an inquiry from a virtual switch executing on a host machine. The inquiry includes a request to identify a flow of a data packet received at the virtual switch from a source virtual processor. The source virtual processor is either a logical partition (LPAR) or a virtual machine (VM) executing under control of a hypervisor on the host machine. A destination virtual processor associated with the data packet is determined by the SDN controller. In addition, the SDN controller identifies the flow between the source virtual processor and the destination virtual processor. The flow includes a least one virtual port in the virtual switch. The SDN controller instructs the virtual switch to send the data packet from the source virtual processor to the destination virtual processor via the identified flow.

### BACKGROUND

The present invention relates generally to software-defined networking (SDN), and more specifically, to using SDN for management of traffic between virtual processors.

Information technology (IT) resources, such as computer processors and networks, are being called upon to support ever greater processing demands, leading to the need for server footprints of increasing size to accommodate these expanding workloads. Virtualization provides a way to abstract the components of today's IT resources to consolidate, integrate, and simplify the required infrastructure and reduce the overall cost of IT resource ownership.

Server virtualization technology allows for the configuration and deployment of multiple logical server configurations on a common physical footprint to provide processing and usage benefits beyond those of the physical configuration. The physical server's resources are abstracted to accommodate the concurrent deployment of multiple instances of virtual processors. Each virtual instance, called a logical partition (LPAR) or virtual machine (VM), is capable of operating a separate operating system (OS) instance and its associated software stacks as if each instance was deployed on a separate physical server. This virtual view offers the benefit of not being restricted by the implementation or configuration of the underlying physical server resources. Each virtual processor instance provides a subset or superset of the various physical server resources that may be dedicated or concurrently shared by multiple LPAR or VM abstractions. By using processor virtualization technologies, the system's processors can be transparently multi-programmed and multi-processed by a virtualization hypervisor to optimize processor sharing by multiple LPAR or VM instances, thereby increasing processor utilization.

In traditional IT network architectures there is no centralized network control. Routing tables located locally in network devices, such as switches, bridges, gateways, routers, or firewalls, are individually configured to direct network traffic to neighboring nodes of the network. The network devices may make control decisions and forward network traffic accordingly. Traditional network architectures are contrasted with software-defined networking (SDN), where network traffic routing decisions are centrally controlled and made by a controller that creates tables to define flow paths through the network. The controller decouples control decisions about where traffic is sent from network devices that forward traffic to a selected destination.

### SUMMARY

Embodiments include methods, systems, and computer program products for software-defined networking (SDN) for management of traffic between virtual processors. A method includes receiving, at a SDN controller, an inquiry from a virtual switch executing on a host machine. The inquiry includes a request to identify a flow of a data packet received at the virtual switch from a source virtual processor. The source virtual processor is either a logical partition (LPAR) or a virtual machine (VM) executing under control of a hypervisor on the host machine. A destination virtual processor associated with the data packet is determined by the SDN controller. The SDN controller identifies the flow between the source virtual processor and the destination virtual processor. The flow includes a least one virtual port in the virtual switch. The SDN controller instructs the virtual switch to send the data packet from the source virtual processor to the destination virtual processor via the identified flow.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a system for implementing software-defined networking (SDN) for management of traffic between virtual processor on a single host machine in accordance with an embodiment;

FIG. 2 depicts a system for implementing SDN for management of traffic between virtual processors on multiple host machines in accordance with an embodiment;

FIG. 3 depicts a block diagram of functions performed by a virtual switch in accordance with an embodiment;

FIG. 4 depicts a block diagram of a SDN controller in accordance with an embodiment; and

FIG. 5 depicts a process flow for performing management of traffic between virtual processors in accordance with an embodiment.

### DETAILED DESCRIPTION

Exemplary embodiments relate to centralized software control of distributed logical partitions (LPARs) and virtual machines (VMs). An embodiment includes a software-defined networking (SDN) controller, at the network layer, that is capable of managing the virtual infrastructure of a network. In particular, the SDN controller can be capable of recognizing LPAR and VM attributes established by a host machine in the network. In an embodiment, the SDN controller associates one-to-one, one-to-many, or many-to-one combinations of virtual processors (e.g., LPARs, VMs) and switches as a unified, distributed LPAR, and can programmatically manage LPAR traffic between distributed LPARs. This can be performed regardless of whether or not an LPAR is subsequently moved to another, different host machine in the network and then back to the original host machine. In order to manage traffic originating at a VM on a particular host machine, virtual identification tags can be assigned to VMs on that host machine which allows the SDN controller to manage/control the VMs like LPARs. For example, traffic may be disallowed from other distributed LPAR partitions in order to provide full isolation similar to traditional LPARs.

As used herein the term distributed LPAR (logical partition) refers to a subset of a computer's hardware resources (processor, memory, and storage) which is divided or virtualized into multiple sets of resources so that each set of resources can be operated independently with its own operating system instance and its own set of applications. The number of logical partitions that can be created depends on the system's processor model and available physical resources. Typically, partitions are used for different purposes such as database operation or client/server operation or to separate test and production environments. Each partition can communicate with the other partitions as if the other partition is in a separate physical machine.

Examples of the types of traffic that can be transmitted between the virtual processors include, but are not limited to, client/server traffic using Ethernet or similar packet-based networking protocols.

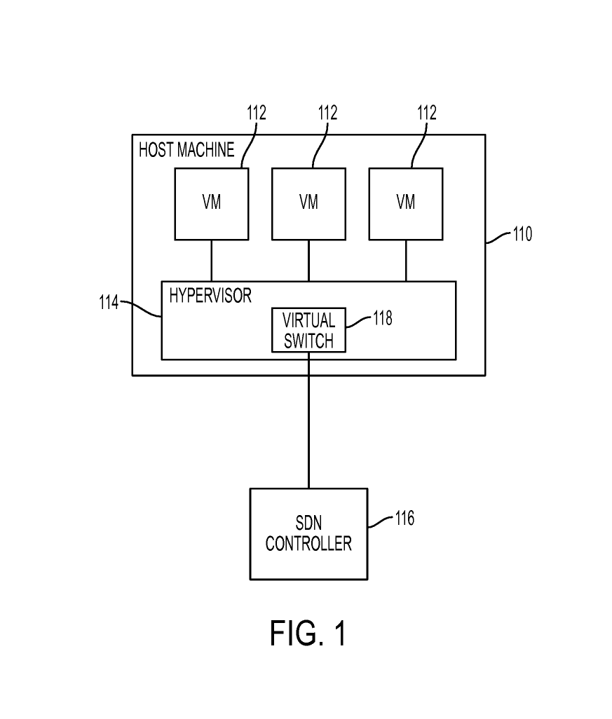

Turning now to FIG. 1, a system for utilizing a SDN controller 116 for managing traffic between virtual processors is generally shown in accordance with an embodiment. The system includes a host machine 110 that is executing multiple VMs 112 as well as a hypervisor 114 and a virtual switch 118. In an embodiment, the SDN controller 116 is in communication with the virtual switch 118 via secure link (e.g., an outband Ethernet link secured via some form of data encryption and/or endpoint authentication and a network connector such as an adapter or network interface card (NIC). The SDN controller 116 can be dedicated to managing traffic between VMs 112 on the host machine 110 or it can be used to manage traffic for multiple host machines. Alternatively, the SDN controller 116 can be used to provide control for a SDN network in addition to managing traffic between VMs. In an embodiment, the SDN controller 116 is located in the host machine 110 and is executing within the hypervisor 114 and/or within one of the VMs 112.

The host machine 110 can be implemented by any high speed processing device that supports virtual processors such as, but not limited to: a System Z® server, a System X® BladeCenter®, or a hybrid processing device that includes a System Z server and a System X BladeCenter server coupled to each other. The host machine 110 can utilize hypervisor functions such as those provided by processor resource/system manager (PRISM). Alternatively, the hypervisor 114 can be implemented by the z/VM software hypervisor.

In an embodiment, the virtual switch 118 is implemented by software that is executed by the hypervisor 114 to simulate a physical switch, such as an ethernet switch. Only one virtual switch 118 is shown in FIG. 1, however, other configurations may include multiple virtual switches 118 that are shared among VMs 112 or dedicated to a particular VM 112.

The example shown in FIG. 1 uses VMs 112 as an example of virtual processors executing on the host machine 110. In another embodiment, the virtual processors are LPARs.

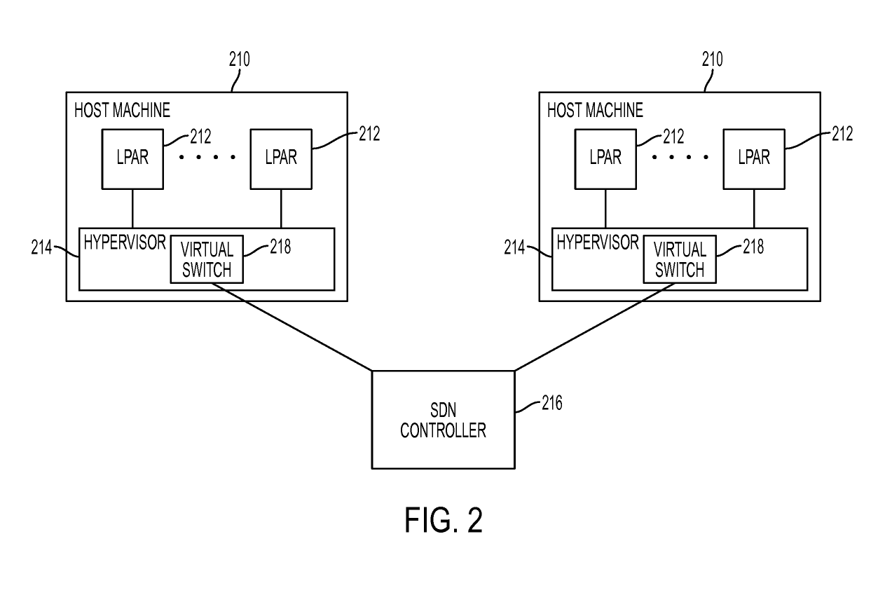

Turning now to FIG. 2, a system for utilizing a SDN controller 216 for managing traffic between virtual processors that are located on two different host machines 210 is generally shown in accordance with an embodiment. The system includes host machines 210 that are executing LPARs 212 as well as hypervisors 214 and virtual switches 218. In an embodiment, the SDN controller 216 is in communication with the virtual switches 218 via a secure link and a network connector such as an adapter or network interface card (NIC). The SDN controller 216 can be dedicated to managing traffic between LPARs 112 on the host machines 110 or it can be used to perform other functions in a SDN network. In an embodiment, the SDN controller 216 is located in one of the host machines 210 and executing within one of the hypervisors 214 and/or within one of the LPARs 212.

The host machines 210 can be implemented by any high speed processing devices that support virtual processors such as, but not limited to: a System Z server, a System X BladeCenter, or a hybrid processing device that includes a System Z server and a System X BladeCenter server coupled together. The host machines 210 can utilize a PR/SM and/or z/VM software hypervisor. In an embodiment, the host machines 210 are connected together and acting as a single host machine.

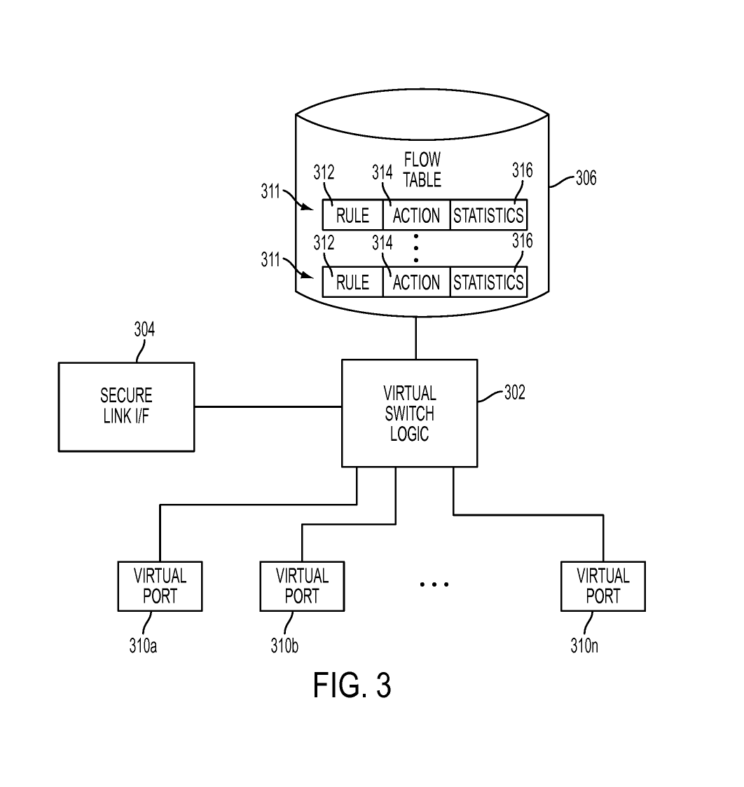

Turning now to FIG. 3, a block diagram of a virtual switch, such as virtual switch 118 or 218 that may be implemented by exemplary embodiments is generally shown. An embodiment of the virtual switch is implemented by software instructions to provide the functions shown in the blocks of FIG. 3. The virtual switch functions shown in FIG. 3 include virtual switch logic 302, a secure link interface 304, a flow table 306, and virtual ports 310a-310n. The virtual switch logic 302 may be implemented in one or more processing circuits, where a computer readable storage medium is configured to hold instructions for the virtual switch logic 302 as well as various variables and constants to support operation of the virtual switch. The virtual switch logic 302 forwards network traffic (e.g., packets) between the virtual ports 310a-310n as flows defined by the SDN controller.

The secure link interface 304 connects the virtual switch to the SDN controller. The secure link interface 304 allows commands and packets to be communicated between the SDN controller and the virtual switch using a SDN protocol. The secure link interface 304 can be controlled by executable instructions stored and executed as part of the virtual switch.

The flow table 306 defines supported connection types associated with particular addresses, virtual local area networks or virtual ports, for example. A flow may be defined as all network traffic that matches a particular header format, including use of wildcards. Each entry 311 in the flow table 306 can include one or more rules 312, actions 314, and statistics 316 associated with a particular flow. The rules 312 define each flow and can be determined by packet headers. The actions 314 define how packets are processed. The statistics 316 track information such as the size of each flow (e.g., number of bytes), the number of packets for each flow, and time since the last matching packet of the flow or connection time. Examples of actions include instructions for forwarding packets of a flow to one or more specific virtual ports 310a-310n (e.g., unicast or multicast), encapsulating and forwarding packets of a flow to the SDN controller, and dropping packets of the flow. Entries 311 in the flow table 306 can be added and removed by the SDN controller via the secure link interface 304. The SDN controller can pre-populate the entries 311 in the flow table 306. Additionally, the virtual switch can request creation of an entry 311 from the SDN controller upon receiving a flow without a corresponding entry 311 in the flow table 306.

A virtual machine has associated with it a number of virtual I/O interfaces, which transmit data packets to a virtual switch in the hypervisor in a manner similar to that used by a physical server connected to a physical switch (but without the need for cables external to the physical server). Each data packet is to be encapsulated with a virtual identification tag by the virtual I/O interface; this tag identifies the packet as coming from a particular virtual machine, and being destined for a particular virtual switch interface. The tags may contain other optional information such as qualify of service tags. The virtual switch is aware of these tags. The virtual switch is managed by the SDN controller, in a similar manner that a physical switch would be managed by an SDN controller, including functions such as providing flow tables to the switch, and implementing specific flows based on match-action tables defined in the SDN controller

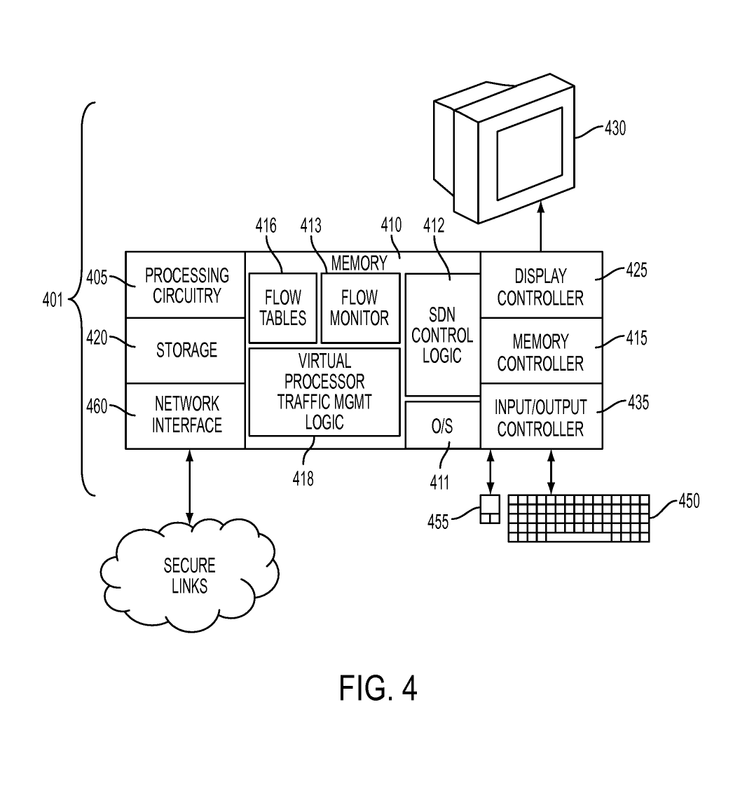

Turning now to FIG. 4, a block diagram of a SDN controller such as SDN controller 116 or 216 is generally shown in accordance with an embodiment. The SDN controller can be embodied in any type of processing system and is depicted embodied in a general-purpose computer 401 in FIG. 4. Alternatively, the SDN controller can be implemented as software instructions and stored as part of a hypervisor or located in a virtual processor.

In an exemplary embodiment, in terms of hardware architecture, as shown in FIG. 4, the computer 401 includes processing circuitry 405 and memory 410 coupled to a memory controller 415, and an input/output (I/O) controller 435. The I/O controller 435 can be, for example but not limited to, one or more buses or other wired or wireless connections, as is known in the art. The I/O controller 435 may have additional elements, which are omitted for simplicity, such as controllers, buffers (caches), drivers, repeaters, and receivers, to enable communications. Further, the computer 401 may include address, control, and/or data connections to enable appropriate communications among the aforementioned components.

In an exemplary embodiment, a conventional keyboard 450 and mouse 455 or similar devices can be coupled to the I/O controller 435. Alternatively, input may be received via a touch-sensitive or motion sensitive interface (not depicted). The computer 401 can further include a display controller 425 coupled to a display 430.

The processing circuitry 405 is a hardware device for executing software, particularly software stored in storage 420, such as cache storage, or memory 410. The processing circuitry 405 can be any custom made or commercially available computer processor, a central processing unit (CPU), an auxiliary processor among several processors associated with the computer 401, a semiconductor-based microprocessor (in the form of a microchip or chip set), a macro-processor, or generally any device for executing instructions.

The memory 410 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), disk, hard disk drive, diskette, cartridge, cassette or the like, etc.). Moreover, the memory 410 may incorporate electronic, magnetic, optical, and/or other types of storage media. Accordingly, the memory 410 is an example of a tangible computer readable storage medium upon which instructions executable by the processing circuitry 405 may be embodied as a computer program product. The memory 410 can have a distributed architecture, where various components are situated remote from one another, but can be accessed by the processing circuitry 405.

The instructions in memory 410 may include one or more separate programs, each of which comprises an ordered listing of executable instructions for implementing logical functions. In the example of FIG. 4, the instructions in the memory 410 include a suitable operating system (OS) 411, SDN control logic 412, and a flow monitor 413. The operating system 411 essentially controls the execution of other computer programs and provides scheduling, input-output control, file and data management, memory management, and communication control and related services. Although depicted separately, the SDN control logic 412 and flow monitor 413 can be combined or further subdivided. When the computer 401 is in operation, the processing circuitry 405 is configured to execute instructions stored within the memory 410, to communicate data to and from the memory 410, and to generally control operations of the computer 401 pursuant to the instructions.

In an exemplary embodiment, the computer 401 can further include a network interface 460 for coupling to the secure links of a SDN network or a host machine. The network interface 460 and components of the SDN network can be configured by the SDN control logic 412 according to flow tables 416. The flow tables 416 can be populated, or augmented, by virtual processor traffic management logic 418. The virtual processor traffic management logic 418 can include computer instructions that are used to identify data packets that are being sent between virtual processors (e.g., LPARs, VMs) on a host machine, to determine actions to take for virtual processor traffic, and/or to aid in initiating a virtual switch for transmitting the data packets.

In an embodiment, the SDN controller receives policy information or configuration data from an orchestration software such as, but not limited Veritas. The policy information can input to the SDN controller via an application programming interface (API) and then be used to determine communication paths between virtual processors. These communication paths can then be used by the SDN controller to instruct the virtual switch to set up a virtual port with dedicated links between the virtual processors having communication paths. In addition, the SDN controller can instruct the virtual switch to record the virtual ports, links and other pertinent data in the flow table on the virtual switch. The virtual ports and links can be set up as part of system initialization and modified during system run time. In addition, virtual ports and links can be set up in response to a particular data packet being received at the SDN controller. Alternatively, the configuration data can be manually entered into the SDN controller.

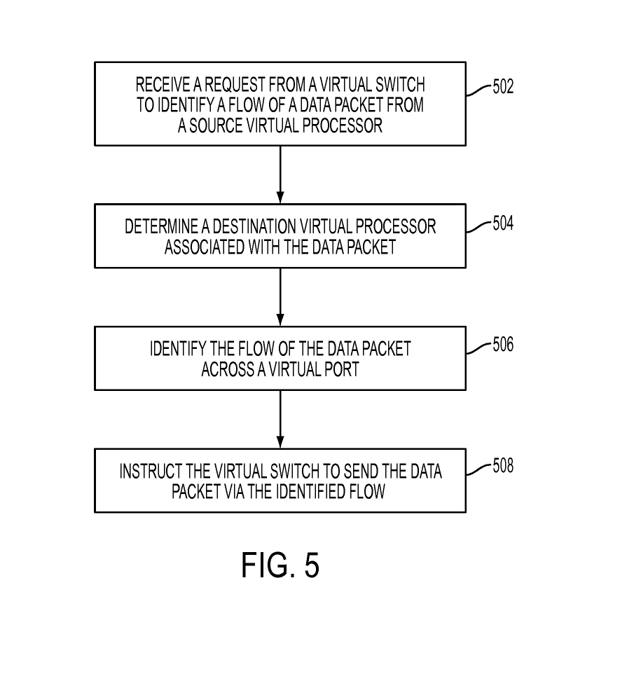

Turning now to FIG. 5, a process flow for management of traffic between virtual processors is generally shown. In an embodiment, the process described in FIG. 5 is performed by a SDN controllers described in FIGS. 1-4. At block 502, a request from a virtual switch to identify a flow of a data packet is received at the SDN controller. In an embodiment, the virtual switch received the data packet from a source virtual processor (e.g. a LPAR or VM) and the virtual switch requires instructions from the SDN controller on how to process the data packet. In an embodiment, the virtual switch is executing under control of a hypervisor on a host machine. At block 504, the SDN controller can determine a destination virtual processor associated with the data packet, and at block 506, the SDN controller can identify the flow between the source virtual processor and the destination virtual processor. In an embodiment, the flow includes at least one virtual port. The SDN controller can use identifier tags assigned to the virtual processors to identify the flow. At block 506, the SDN controller instructs that the virtual switch to send the data packet from the source virtual processor to the destination virtual processor via the identified flow.

Technical effects and benefits include the ability to provide complete isolation between LPARs and VMs. Further, this approach includes the ability to address a number of issues with virtual machine management which are not as highly developed as logical partition implementations. For example, there are different types of virtual machines, some of which are designed to run a complete operating system and some of which are designed to run a specific program; our proposed approach facilitates workload optimization between different types of virtual machines and LPARs. Further, the virtual machine can implement an instruction set architecture which is different from that of the physical underlying system and from the LPARs; our proposed approach facilitates network management that can optimize traffic flows between different instruction set architectures. Further, when multiple VMs are concurrently running on the same physical host, each VM may exhibit a varying and unstable performance (i.e. variable speed of execution), which highly depends on the workload imposed on the system by other virtual machines, unless proper techniques are used for temporal isolation among virtual machines; our approach facilitates this type of temporal isolation.

As will be appreciated by one of average skill in the art, aspects of embodiments may be embodied as a system, method or computer program product. Accordingly, aspects of embodiments may take the form of an entirely hardware embodiment, an entirely software embodiment (including firmware, resident software, micro-code, etc.) or an embodiment combining software and hardware aspects that may all generally be referred to herein as, for example, a “circuit,” “module” or “system.” Furthermore, aspects of embodiments may take the form of a computer program product embodied in one or more computer readable storage device(s) having computer readable program code embodied thereon.

One or more of the capabilities of embodiments can be implemented in software, firmware, hardware, or some combination thereof. Further, one or more of the capabilities can be emulated.

An embodiment may be a computer program product for enabling processor circuits to perform elements of the invention, the computer program product comprising a computer readable storage medium readable by a processing circuit and storing instructions for execution by the processing circuit for performing a method.

The computer readable storage medium (or media), being a tangible, non-transitory, storage medium having instructions recorded thereon for causing a processor circuit to perform a method. The “computer readable storage medium” being non-transitory at least because once the instructions are recorded on the medium, the recorded instructions can be subsequently read one or more times by the processor circuit at times that are independent of the time of recording. The “computer readable storage media” being non-transitory including devices that retain recorded information only while powered (volatile devices) and devices that retain recorded information independently of being powered (non-volatile devices). An example, non-exhaustive list of “non-transitory storage media” includes, but is not limited to, for example: a semi-conductor storage device comprising, for example, a memory array such as a RAM or a memory circuit such as latch having instructions recorded thereon; a mechanically encoded device such as punch-cards or raised structures in a groove having instructions recorded thereon; an optically readable device such as a CD or DVD having instructions recorded thereon; and a magnetic encoded device such as a magnetic tape or a magnetic disk having instructions recorded thereon.

A non-exhaustive list of examples of computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM). Program code can be distributed to respective computing/processing devices from an external computer or external storage device via a network, for example, the Internet, a local area network, wide area network and/or wireless network. The network may comprise copper transmission cables, optical transmission fibers, wireless transmission, routers, firewalls, switches, gateway computers and/or edge servers. A network adapter card or network interface card in each computing/processing device receives a program from the network and forwards the program for storage in a computer-readable storage device within the respective computing/processing device.

Computer program instructions for carrying out operations for aspects of embodiments may be for example assembler code, machine code, microcode or either source or object code written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable storage medium that can direct a computer, other programmable data processing apparatus, or other devices to function in a particular.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of software-defined networking (SDN) for management of traffic between virtual processors, the method comprising:
receiving, at a SDN controller, an inquiry from a virtual switch executing on a host machine, the inquiry including a request to identify a flow of a data packet received at the virtual switch from a source virtual processor, the source virtual processor one of a logical partition (LPAR) and a virtual machine (VM) executing under control of a hypervisor on the host machine;
determining, at the SDN controller, a destination virtual processor associated with the data packet;
identifying, at the SDN controller, the flow between the source virtual processor and the destination virtual processor, the flow including a least one virtual port in the virtual switch; and
instructing the virtual switch to send the data packet from the source virtual processor to the destination virtual processor via the identified flow.

2. The method of claim 1, wherein the destination virtual processor is one of a LPAR and a VM.

3. The method of claim 1, wherein the destination virtual processor is executing under control of the hypervisor on the host machine.

4. The method of claim 1, wherein the source virtual processor and the destination virtual processor are executing on different host machines having different architectures.

5. The method of claim 1, further comprising initializing the virtual switch to support traffic being sent between the source virtual processor and the destination virtual processor, the initializing including reserving the virtual port for data packets being sent between the source virtual processor and the destination virtual processor.

6. The method of claim 1, wherein the identifying is based on configuration data received via an application programming interface (API) at the SDN controller.

7. The method of claim 1, wherein the source and destination virtual processors are assigned virtual processor identifier tags that are utilized by the SDN controller to identify the flow.

8. A system for software-defined networking (SDN) for management of traffic between virtual processors, the system comprising:
a SDN controller, the system configured perform a method comprising:
receiving an inquiry from a virtual switch executing on a host machine, the inquiry including a request to identify a flow of a data packet received at the virtual switch from a source virtual processor, the source virtual processor one of a logical partition (LPAR) and a virtual machine (VM) executing under control of a hypervisor on the host machine;
determining a destination virtual processor associated with the data packet;
identifying the flow between the source virtual processor and the destination virtual processor, the flow including a least one virtual port in the virtual switch; and
instructing the virtual switch to send the data packet from the source virtual processor to the destination virtual processor via the identified flow.

9. The system of claim 8, wherein the destination virtual processor is one of a LPAR and a VM.

10. The system of claim 8, wherein the destination virtual processor is executing under control of the hypervisor on the host machine.

11. The system of claim 8, wherein the source virtual processor and the destination virtual processor are executing on different host machines having different architectures.

12. The system of claim 8, wherein the method further comprises initializing the virtual switch to support traffic being sent between the source virtual processor and the destination virtual processor, the initializing including reserving the virtual port for data packets being sent between the source virtual processor and the destination virtual processor.

13. The system of claim 8, wherein the identifying is based on configuration data received via an application programming interface (API) at the SDN controller.

14. The system of claim 8, wherein the source and destination virtual processors are assigned virtual processor identifier tags that are utilized by the SDN controller to identify the flow.

15. A computer program product for software-defined networking (SDN) for management of traffic between virtual processors, the computer program product comprising:
a tangible storage medium readable by a processing circuit and storing instructions for execution by the processing circuit for performing a method comprising:
receiving an inquiry from a virtual switch executing on a host machine, the inquiry including a request to identify a flow of a data packet received at the virtual switch from a source virtual processor, the source virtual processor one of a logical partition (LPAR) and a virtual machine (VM) executing under control of a hypervisor on the host machine;
determining a destination virtual processor associated with the data packet;
identifying the flow between the source virtual processor and the destination virtual processor, the flow including a least one virtual port in the virtual switch; and
instructing the virtual switch to send the data packet from the source virtual processor to the destination virtual processor via the identified flow.

16. The computer program product of claim 15, wherein the destination virtual processor is one of a LPAR and a VM.

17. The computer program product of claim 15, wherein the destination virtual processor is executing under control of the hypervisor on the host machine.

18. The computer program product of claim 15, wherein the source virtual processor and the destination virtual processor are executing on different host machines having different architectures.

19. The computer program product of claim 15, wherein the method further comprises initializing the virtual switch to support traffic being sent between the source virtual processor and the destination virtual processor, the initializing including reserving the virtual port for data packets being sent between the source virtual processor and the destination virtual processor.

20. The computer program product of claim 15, wherein the identifying is based on configuration data received via an application programming interface (API) at the SDN controller.
